(19) United States
(12) Patent Application Publication
(10) Pub. No.: US 2003/0068465 A1
(43) Pub. Date: Apr. 10, 2003

(54) Water-impermeable carpet

(76) Inventors: Hiroaki Morimoto, Kobe-shi (JP); Yasunobu Nakagoshi, Kobe-shi (JP)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/256,320

(22) Filed: Sep. 27, 2002

(30) Foreign Application Priority Data
Oct. 9, 2001 (JP) 2001-311100

(51) Int. Cl. B32B 33/00; D05C 17/02

(52) U.S. Cl. 428/95; 428/96

(57) ABSTRACT

A tufted carpet included a backing bonded to a tufted base with a layer of adhesive containing powder of a far-infrared radiating material. The adhesive layer not only prevents water on the upper surface of the carpet from penetrating through the carpet to the bottom of the carpet, but also warms the carpet so that the water can be evaporated.

This invention relates to a tufted carpet and, more particularly, to a water-impermeable tufted carpet.

### BACKGROUND OF THE INVENTION

A known tufted carpet includes a base formed of coarse plain-woven cloth of, for example, jute or synthetic fiber or unwoven fabric, and a tuft of, for example, wool or synthetic fiber tufted to the base by means of a tufting machine. A backing is bonded with an adhesive to the back side of the base with the tuft for fixing the tuft to the base. The backing functions also as a support of the completed carpet. The backing is formed of plain-woven cloth of, for example, jute or synthetic fiber, or unwoven fabric.

Carpets are frequently spread on a wooden floor. A tufted carpet cannot be said to have sufficient water-shielding ability. If a pet passes urine or water is spilled on a tufted carpet, it is not possible to wipe away or remove completely the spilled water from the carpet, and the remaining water will penetrate through the carpet to the back or bottom side of the carpet when a man walks on the soaked portion of the carpet. The water on the bottom side of the tufted carpet can be hardly evaporated and remains there for a long time to erode the carpet and/or the floor.

An object of the present invention is to provide a tufted carpet which can prevent water on the upper surface of the carpet from moving to the back side of the carpet and can allow water to evaporate easily so that erosion of the carpet and/or stain of the floor due to moisture can be prevented.

### SUMMARY OF THE INVENTION

According to the present invention, as an adhesive used to bond a tuft to a base, a synthetic resin adhesive or rubber adhesive with particles or powder of an far-infrared radiating material added to it is used. The adhesive is applied to form a layer which covers the entire back surface of the base. Generally, the layer of the adhesive applied over the back surface of the base need to be 100 μ in thickness or thicker.

By covering the entire back surface of the base with the above-described adhesive, water spilled over the upper side of the carpet is prevented from penetrating to the back side of the carpet, and, in addition, the far-infrared radiating material in the adhesive functions to heat the tuft, which helps water remaining on the upper side of the carpet to evaporate rapidly.

### BRIEF DESCRIPTION OF THE DRAWINGS

FIGS. 1A and 1B are cross-sectional views of tufted carpets according to different embodiments of the present invention;

FIG. 2 is a cross-sectional view of a tufted carpet according to the present invention without a backing, being subjected to measurement of temperature increase caused by directly heating its adhesive layer;

FIG. 3 is a cross-sectional view, similar to FIG. 2, of a prior art tufted carpet, being subjected to measurement of temperature increase caused by directly heating its adhesive layer;

FIG. 4 is a cross-sectional view of the tufted carpet according to the present invention without a backing, being subjected to measurement of temperature increase caused by heating the tufted side of the carpet; and

FIG. 5 is a cross-sectional view, similar to FIG. 4, of the prior art tufted carpet, being subjected to measurement of temperature increase caused by heating the tufted side of the carpet.

### DESCRIPTION OF PREFERRED EMBODIMENTS

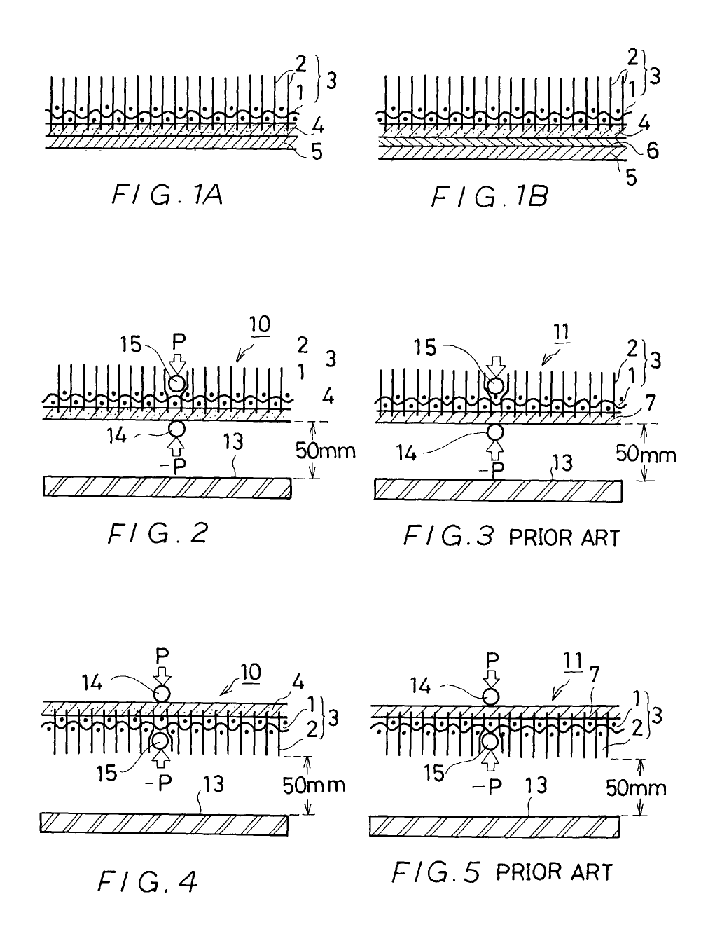

FIG. 1A is a cross-sectional view of a tufted carpet according to one embodiment of the present invention. The tufted carpet includes a base 1 formed of strong cloth, for example, coarse plain-woven jute or synthetic fiber cloth, or unwoven fabric, and a tuft 2 of, for example, wool or synthetic fiber tufted to the base 1. The base 1 and the tuft 2 form a “tufted sheet” 3. In the drawings, the tuft 2 is represented by a number of upright solid line. Each line represents an upright yarn formed of a large number of twined filaments, and the lower end of each yarn is forced to pass through the base 1 to a depth slightly beyond the lower surface of the base 1.

A backing cloth 5 is bonded to the lower surface of the base 1 by means of a layer 4 of an adhesive containing powder of a far-infrared radiating material.

The far-infrared radiating material can be at least one member selected from a group of alumina, silica, zirconia, graphite, carbon, silicon carbide, and titanium oxide. The grain diameter of the far-infrared radiating material should be 300μ or less from the view point of the strength and water-shielding property of the adhesive layer 4. Practically, the grain diameter is desirably from 5μ to 100 μ.

The adhesive component of the adhesive layer 4 may be a synthetic resin adhesive, for example, an ethylene-acetate vinyl adhesive, a polyurethane adhesive, an acrylic adhesive, a polyester adhesive, or a silicone adhesive. Alternatively, it may be a rubber adhesive, for example, a SBR adhesive, a chloroprene adhesive, a urethane rubber adhesive, a silicone rubber adhesive, or a natural rubber adhesive. The adhesive may be of hot-melt type, an organic solvent type, or an aqueous type. An aqueous ethylene-acetate vinyl adhesive is the most preferable.

The amount of the far-infrared radiating material to be added to the adhesive to form the adhesive layer 4 is suitably from 3 to 70 parts by weight to 100 parts by weight of solid content of the adhesive. If the amount is less than 3 parts by weight, the far-infrared radiating material can hardly exhibit its effect. On the other hand, if the amount is more than 70 parts by weight, the water shielding function and adhesion strength of the adhesive layer 4 extremely decreases. In particular, when the grain diameter of the far-infrared radiating material in the adhesive layer 4 is larger, the adhesion of the layer 4 tends to decrease more, and, therefore, the amount of the far-infrared radiating material should be smaller.

The backing cloth 5 is bonded to the bottom of the tufted sheet 3 for preventing the carpet from undulating and distorting when it is spread over a floor. Commonly, a plain-woven fabric of jute or polypropylene is used for the backing 5, but other cloth, e.g. unwoven fabric, felt or cheesecloth, may be used.

FIG. 1B shows a tufted carpet according to another embodiment of the present invention. This carpet is different from the carpet of FIG. 1A in that it includes another adhesive layer 6 disposed between the adhesive layer 4 and the backing 5. Different from the adhesive layer 4, the adhesive layer 6 is an ordinary adhesive used in the pertinent technical field and does not contain a far-infrared radiating material.

The adhesive layer 6 is used to reinforce the adhesion provided by the adhesive layer 4. Tufting sometimes may produce undulations in the back surface of the base 4. In such a case, the adhesive layer 4 may not provide sufficient adhesion of the base 1 to the backing 5. Then, the adhesive layer 6 can reinforce such adhesion.

The adhesive layer 6 may be used also when the amount of the far-infrared radiating material in the adhesive layer 4 is too large to provide sufficient adhesion or strength.

Also, the adhesive layer 6 may be used when the adhesive layer 4 cannot provide sufficient water-shielding effect.

Tests have been conducted to demonstrate the effects provided by the use of the adhesive layer 4 containing the far-infrared radiating material.

First, a tufting machine was used to provide tuft 2 to the base 1, which is formed of unwoven fabric of synthetic resin, to thereby produce the tufted sheet 3. To 100 parts by weight in terms of solid content of an aqueous ethylene-vinyl acetate copolymer whose solid content was 50%, 30 parts by weight of graphite powder having a particle diameter of about 30μ were added, and the mixture was stirred to prepare an adhesive for the adhesive layer 4. The adhesive was applied over the back (lower) surface of the tufted sheet 3 to such a thickness as to provide a thickness of 0.4 mm, after drying, to the adhesive layer 4. Drying the adhesive layer 4 resulted in the tufted carpet 10 shown in FIG. 2 or in FIG. 4.

An aqueous ethylene-vinyl acetate copolymer resin having the same composition used for the adhesive layer 4, but without the far-infrared radiating material, was applied to the back surface of the tufted sheet 3 to such a thickness as to provide an adhesive layer 7 having a thickness of 0.4 mm, after drying, to thereby prepare a tufted carpet 11 for comparison shown in FIG. 3 or FIG. 5.

As shown in FIGS. 2 and 3, a heat source plate 13 having its surfaces maintained at 42° C. was placed to be in parallel with and to face the adhesive layers 4 and 7 with a spacing of 50 mm disposed therebetween. A temperature sensor 14 was urged against the adhesive layers 4 and 7 to measure their surface temperatures, and a temperature sensor 15 was urged against the opposite, tufted side of each of the tufted sheets 3 as shown in FIGS. 2 and 3, to measure the surface temperatures. Sufficient pressures P and −P comparable to the pressure which would be applied when a human stand there were applied to the sensors 14 and 15.

Similarly, as shown in FIGS. 4 and 5, the heat source plate 13 was placed to face in parallel with the tufted side of each of the carpet 10 and 11 with a spacing of 50 mm disposed therebetween. As in the case of FIGS. 2 and 3, the sensor 15 applied with the sufficient pressure −P was used to measure the surface temperature of the side with the tuft 2, while the sensor 14 with a sufficient pressure P applied to it was used to measure the surface temperature of the adhesive layers 4 and 7.

The result of the measurements is shown in TABLE 1.

TABLE 1

| | Temperatures Measured | | | |
|---|---|---|---|---|
| | with Adhesive Layers 4 | | Temperatures Measured | |
| | and 7 Facing to Heat | | with Tufted Sides Facing | |
| | Source Plate 13 | | to Heat Source Plate 13 | |
| | (FIGS. 2 and 3) | | (FIGS. 4 and 5) | |
| | Sensor 14 | Sensor 15 | Sensor 14 | Sensor 15 |
| Tufted Carpet 10 | 35.0° C. | 31.5° C. | 32.0° C. | 34.1° C. |
| (Present Invention) | | | | |
| Tufted Carpet 11 | 32.8° C. | 30.0° C. | 31.0° C. | 32.0° C. |
| (Prior Art) | | | | |

When the heat was applied to the adhesive layers 4 and 7 of the carpet 10 of the present invention and the prior art carpet 11, as shown in FIGS. 2 and 3, respectively, the temperature of the adhesive layer 4 was higher by 2.2° C. than the temperature of the adhesive layer 7, and the temperature of the tuft 2 of the carpet 10 was higher by 1.5° C. than the temperature of the tuft 2 of the prior art carpet 11.

When the heat was applied to the carpets 10 and 11 from the tufted sides, as shown in FIGS. 4 and 5, the temperature of the adhesive layer 4 of the carpet 10 of the present invention was higher by 1.0° C. than the temperature of the adhesive layer 7 of the prior art carpet 11, and the temperature of the tuft 2 of the carpet 10 was higher by 2.1° C. than the temperature of the tuft 2 of the prior art carpet 11.

Usually, carpets are heated by infrared radiation from lamps, heating systems, various electric appliances, the sun and so forth. Accordingly, temperature of carpets according to the present invention increases higher than prior art carpets. Thus, according to the present invention, water absorbed by the base 1 and the tuft 2 can be readily evaporated due to the effects of the far-infrared radiation so that water can be more effectively prevented from moving from the upper surface of the carpet to the bottom or lower surface of the carpet.

Another advantage of the present invention is alleviation of coldness coming up through the carpet from the floor to people sitting on the carpet. If the carpet according to the present invention is spread over a heated floor, the energy for the air-conditioning of the room can be reduced.

What is claimed is:

1. A water-impermeable carpet comprising a tufted base, a backing, and a layer of an adhesive bonding said backing to a bottom surface of said tufted base for fixing base portions of tufts, wherein powder of a far-infrared radiating material is mixed into said adhesive layer.

2. The carpet according to claim 1 wherein said far-infrared radiating material comprises at least one member selected from a group of alumina, silica, zirconia, graphite, carbon, silicon carbide and titanium oxide.

3. The carpet according to claim 1 wherein the grain diameter of said powder of far-infrared radiating material is 300μ or less.

4. The carpet according to claim 3 wherein the grain diameter of said powder of far-infrared radiating material is from 5 p to 100 μ.

5. The carpet according to claim 1 wherein from 3 parts by weight to 70 parts by weight of said powder of far-infrared radiating material is added to 100 parts by weight of a solid content of said adhesive.

6. The carpet according to claim 1 wherein the thickness of said adhesive layer is not smaller than 0.1 mm and not greater than 5.0 mm.

7. A water-impermeable carpet comprising a tufted base, a first layer of adhesive on a bottom surface of said tufted base for fixing base portions of tufts, a backing, and a second layer of adhesive bonding said backing to said first adhesive layer, wherein powder of a far-infrared radiating material is mixed into said first adhesive layer.

8. The carpet according to claim 7 wherein said far-infrared radiating material comprises at least one member selected from a group of alumina, silica, zirconia, graphite, carbon, silicon carbide and titanium oxide.

9. The carpet according to claim 7 wherein the grain diameter of said powder of far-infrared radiating material is 300μ or less.

10. The carpet according to claim 9 wherein the grain diameter of said powder of far-infrared radiating material is from 5 μ to 100μ.

11. The carpet according to claim 7 wherein from 3 parts by weight to 70 parts by weight of said powder of far-infrared radiating material is added to 100 parts by weight of a solid content of said adhesive.

12. The carpet according to claim 7 wherein the thickness of said adhesive layer is not smaller than 0.1 mm and not greater than 5.0 mm.
